(19) United States
(12) Patent Application Publication
(10) Pub. No.: US 2004/0255340 A1
(43) Pub. Date: Dec. 16, 2004

(54) Methods and apparatus for playing different programs to different listeners using a compact disk player

(75) Inventor: James D. Logan, Candia, NH (US)

Correspondence Address: CHARLES G. CALL, 68 HORSE POND ROAD, WEST YARMOUTH, MA, 02673-2516, US

(73) Assignee: Gotuit Audio, Inc.

(21) Appl. No.: 10/767,925

(22) Filed: Jan. 29, 2004

Related U.S. Application Data
(63) Continuation-in-part of application No. 10/331,198, filed on Dec. 30, 2002.
(63) Continuation-in-part of application No. 09/536,969, filed on Mar. 28, 2000.
(63) Continuation-in-part of application No. 10/060,001, filed on Jan. 29, 2002.
(63) Continuation-in-part of application No. 10/165,587, filed on Jun. 8, 2002.
(60) Provisional application No. 60/443,376, filed on Jan. 29, 2003.

(51) Int. Cl. H04N 7/173; H04N 7/16

(52) U.S. Cl. 725/145; 725/115; 725/93

(57) ABSTRACT

A compact disk player includes a digital storage device which receives and stores two different programs, such as song tracks or the like, at a high rate of speed. Two output devices play back the two different programs at the same time at a slower reproduction rate. The arrangement includes separate controls associated with each output device, permitting different listeners to independently select the particular program played on each output device.

### CROSS REFERENCE TO RELATED APPLICATIONS

This application is a non-provisional of U.S. Patent Application Ser. No. 60/443,376 filed Jan. 29, 2003; a continuation-in-part of U.S. patent application Ser. No. 09/536,969 filed Mar. 28, 2000; a continuation-in-part of U.S. patent application Ser. No. 10/060,001 filed on Jan. 29, 2002 published as U.S. Application Publication No. 2002/0120925; a continuation in part of U.S. patent application Ser. No. 10/165,587 filed on Jun. 8, 2002 published as U.S. Application Publication 2003/0093790; and a continuation-in-part of U.S. patent application Ser. No. 10/331,198 filed on Dec. 30, 2002 published as U.S. Application Publication No. 2003/0163823. The disclosures of each of the foregoing applications are hereby incorporated herein by reference.

### FIELD OF THE INVENTION

This invention relates to digital audio and video playback systems and more particularly, although in its broader aspects not exclusively, to improved mechanisms for playing CDs and DVDs.

### BACKGROUND OF THE INVENTION

Compact disk players (CD and DVD players) are commonly installed in vehicles. Many vans and SUVs have controls for the radio and CD player that are accessible by the backseat passengers. Passengers in the backseat may control the main (and only) radio and CD device with skip, volume, radio preset and controls. These backseat controls alter the sound that can be heard over the normal speaker system, or over headphones that plug into a backseat console, allowing these passengers to listen to the music privately. If headphones are used, the other passengers typically cannot listen to the selected music and in most systems they cannot listen to the other audio sources (the radio or cassette tape) either.

Increasingly then, passengers are listening to their own music sources. Between video systems in high-end cars, portable CD players, and back seat controls, many families consist of a car-full of passengers all listening to music of their own choice. The vehicle is becoming less of a place where people enjoy a common listening experience and more of a place where people want personalized music choice. Given this trend, the leading purpose of the present invention is to allow greater playback choice by giving two or more people the ability to listen to different programs (e.g. tracks) on the same compact disk player.

Individual program choice is needed even for a single-CD player. Because the system contemplated by the invention can potentially make available a large number of program selections on one or multiple volumes, it would be unlikely that any two people would be interested in listening to the exact same program or playlist at the same time. Therefore, a personalized navigation and listening feature for that category of device would definitely be valued. For a multi-CD changer, with six or more CDs able to be accessed on demand, the chances of two people wanting to hear the same tracks, at the same time, assuming they had the option for personalized listening via headphones, would be small. Even with a single CD, different people in the car would most likely have different opinions regarding which song to play next, or replay, etc. And with MP3 recordings on compact disk or in a hard drive, many times the number of songs as one standard CD are commonly available, still further reducing the likelihood of two people will want to hear the same program content at the same time.

One solution is to have two or more standalone players in the car. But the backseat listener will still have to wear headphones. This solution also increases cost, uses scarce surface area, locates one or more breakable and unrestrained devices in the passenger area, and increases the difficulty of locating CDs which become spread over the car. In addition, with two CD players playing two CDs, it is difficult to share a common listening experience when that is desired.

### SUMMARY OF THE INVENTION

Currently, many CDs already have “anti-skip buffer,” often 45 seconds long, to provide proper playback even when the drive skips tracks. The anti-skip feature is commonly incorporated into portable players and players installed in vehicles that are subject to shock and vibration that may cause the pickup to skip tracks. By buffering content read from the disk at a higher rate in advance of playback, when a track jump occurs, the output reproduction device can continue to play from the buffered content while the pickup head is repositioned to capture the skipped content. This present invention also uses buffered content, perhaps in expanded form, to provide another function: supplying a second listener with different program content.

The playback system contemplated by the invention may be used to concurrently reproduce two (or more) different programs on two (or more) different output devices being used by two (or more) different users. To achieve this, the disk transport delivers program data from the disk to a digital memory at a rate which is at least twice as fast as the rate at which the data needs to be reproduced by an output device (the reproduction rate). For example, the transport may deliver program data to the digital memory at eight times (8×) the reproduction rate. The digital memory buffers the data read sequentially from different programs by the transport, and then supplies that data to each playback device which operates at the slower reproduction rate. Each user is provided with interface controls that enable that user to independently navigate and play back programs that are different from other programs being reproduced at the same time, perhaps from the same disk volume or different disk volumes, for other users.

By using the multi-listener capabilities provided by the present invention, two listeners may be listening to different programs on the same CD, which can't be achieved using separate players. Using these capabilities, a usage session might start with both the front seat and back seat listeners hearing the same thing. As soon as the backseat listener's taste diverged from the front seat listener's, the headphones could just be slid on and a new track found. No more fights until the CD was over. At the same time, it is possible for two users to listen to the same CD at the same time.

The principles of the invention may also be applied to provide multi-listener capabilities to a CD or to a MP3 collection stored on a hard drive, or to other kinds of electronic recording devices delivering digitally encoded music.

These and other features of the invention will become more apparent through a consideration of the following detailed description.

### BRIEF DESCRIPTION OF THE DRAWINGS

In the detailed description which follows, frequent reference will be made to the attached drawings, in which:

FIG. 1 is a block diagram showing the principal components used to implement an embodiment of the invention; and

FIG. 2 is a flow chart illustrating the steps taken during the operation of the embodiment of FIG. 1.

### DETAILED DESCRIPTION

The preferred embodiment of the present invention described below is an improved CD and/or DVD playback system which possesses novel features which address the objective of providing better ways to listen to, or watch, program content stored on CD and/or DVD collections.

The system incorporates, or may be modified to incorporate, mechanisms described in the pending applications noted above, and in U.S. Pat. No. Re36,801 issued to James D. Logan et al. on Aug. 1, 2000 entitled “Time delayed digital video system using concurrent recording and playback” and U.S. Pat. No. 6,088,455 issued to James D. Logan et al. on Jul. 11, 2000 entitled “Systems and Methods for Modifying Broadcast Programming,” the disclosures of which are also incorporated herein by reference.

The improved compact disk player to be described incorporates a number of novel and useful features and functions which may be briefly summarized as follows:

1. The player allows different users to hear or view different programs at the same time;

2. The player can change program segments (music tracks or video programs) immediately, without a delay between programs as a new track is selected, possibly on a new media volume that must be loaded onto the transport;

3. The player “remembers” the content of CD or DVD disks previously mounted on the transport, creating a program guide that enables users to not only view text descriptions but also to hear or view samples of the recorded programming while making program selections or building playlists; and

4. The player enables a viewer or listener to manually or automatically “scan” samples of the available programming to rapidly and intuitively select desired programs for playback.

System Overview

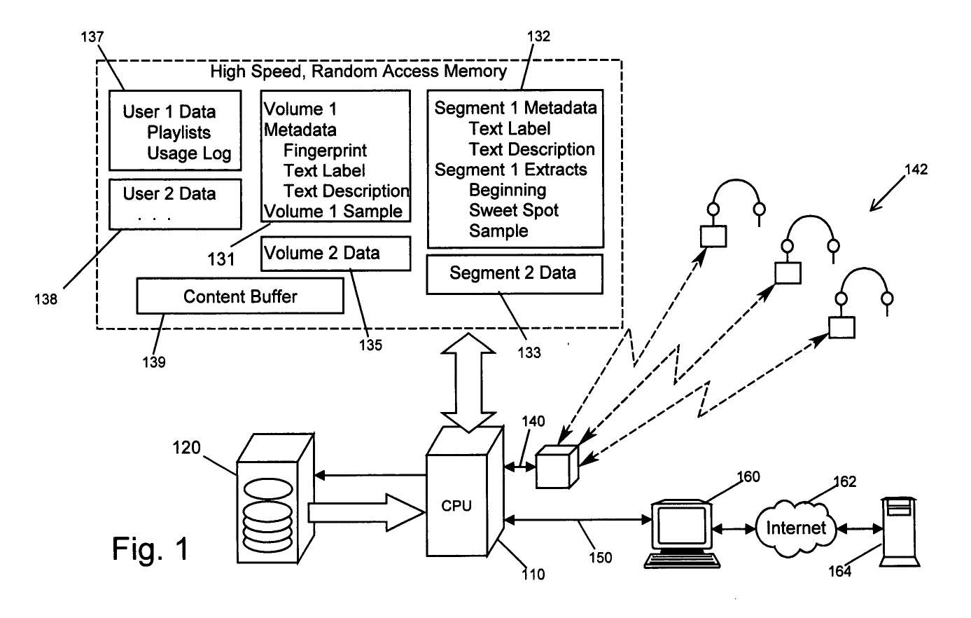

The principal hardware components used to implement these and other features of the preferred embodiment are shown in FIG. 1 of the drawings. The system consists of a central processing unit (CPU) 110, also referred to herein as the “controller,” which directs the operation of other devices, including a disk player 120, a high-speed random-access high-capacity memory subsystem 130, an I/O port 140 coupled to user-controlled program reproduction devices indicated generally at 142, and further I/O port 150 coupled to an external source of program description metadata, such as a personal computer (PC) 160 that obtains metadata via the Internet 162 from a remote database server 164.

The disk player 120 is conventional, and may be capable of reproducing audio or program data recorded on disks in one or more of a variety of standard formats, including those commonly designated as CD-ROM, CD-ROM/XA, CD-I, CD-R, CD-RW, DVD, DVD-RAM, and DVD+RW. These disks may be purchased, or may be created by or for the user and contain recordings in MP3 or other compressed format. In this specification, references to a “CD,” “compact disk,” “CD player,” “compact disk player” or “CD drive” or should be understood to refer to any kind of CD or DVD and to devices capable of reproducing program content therefrom. Also, it should be understood that terms like “listener” used here to describe audio playback from a CD may also be understood to refer to a “viewer” of video programming on a DVD.

The disk player 120 consists of a disk drive mechanism which, in the case of multi-disk players, includes a disk carousel, magazine or turntable for automatically retrieving a selected disk volume from a collection and mounting it on the playback transport. The transport is conventional and typically includes a laser pickup system, a servo system for rotating the disk and positioning the pickup to reproduce selected programming recorded on the disk, and data decoding electronics for demodulating the data as recorded in EFM (eight-to-fourteen) format on the disk, and translating the Cross Interleave Read-Solomon Code (CIRC) error detection and correction code into a multiplexed data string which contains both the right and left channels of an audio recording. The disk player 120 responds to selection signals 121 from the controller 110 by selecting particular portions of the program content recorded on the disk volume that is currently mounted on the transport. In the case of multi-disk players, the selection signal 121 may also request that a designated volume located on the turntable, carousel or magazine be mounted on the playback transport as the active disk. The program content reproduced by the pickup is transferred under DMA control as one or more blocks of data moved via the output 124 to the memory 130.

The controller 110 is preferably a conventional microprocessor which includes one or more direct memory access (DMA) controllers for moving audio or video program data between the player 120 and a high speed random access memory subsystem 130. The digital memory 130 preferably comprises the combination of dynamic RAM and one or more high-capacity persistent storage devices, such as flash memory and/or one or more hard disk memory units, and is characterized by its ability to provide high speed random access to the metadata and program content it stores without exhibiting the speed limitations imposed by the mechanically moving parts used in the player 120.

The memory subsystem 130 persistently stores “surrogate data” that describes the content of each of multiple available CD volumes. As illustrated at 131 for a first CD volume, each volume is described by metadata which preferably includes: (1) identification information (a “volume fingerprint”) that uniquely identifies the volume; (2) a short text “label” for the volume such as an album title; and (3) a longer text description of the content of the volume. Both the label and the longer description are typically expressed as textual character data, but may include image data (e.g. an image of an album cover) or a voice narration describing the content. The metadata for each volume also preferably includes (4) a short sample of the volume's content, or a pointer to (disk address information identifying the beginning and ending of) content recorded on the disk volume which may be extracted and placed in the memory system 130 when the disk is mounted for playback.

Similarly, as seen at 132 for “program 1” on “volume 1”, the memory subsystem stores surrogate content data describing each program (e.g. song track, music video, etc.) on each volume. The program surrogate data preferably includes (1) a title and (2) a longer description, both expressed in text or other form, and either the content of, or a pointer to, sample extracts from each program. As in the case of the volume sample, when a pointer alone is provided, it may be used to retrieve an identified portion of the program from the disk volume when that volume is mounted, with the identified sample(s) for each program are thereafter persistently stored in the higher speed memory subsystem. As seen in FIG. 1, data for a second “program 2” in “volume 1” is stored at 133, while data describing a second “volume 2” is stored at 135.

When each available CD volume is first mounted on the disk player 120, extracts are retrieved from each program (e.g. audio song track) recorded on that volume. These extracts include the beginning of each program, and may include an additional “sweet spot” or longer “sample” of the program which provides the listener with a better preview of the content of that program. When text metadata describing the content of a volume is obtained from an external source (such as the Internet server 164), that metadata may include pointer data which identifies the portion of each program to be extracted as a “sweet spot” or “sample.” As explained later, the beginning, sweet spot and sample extracts are stored in the high speed memory to support different outputs to different users as well as improved program guide and navigation functions.

The beginning of each program segment (e.g. each song track on each available CD) on each mounted CD) are read from each CD when it is first mounted on the player 120 and are thereafter persistently stored for later use. The storage of beginning segments permits the user to select and immediately begin playing a desired selection, possibly on a different CD from the currently mounted CD, without experiencing a delay. The stored “beginning segment” of the new selection is read from the high speed memory subsystem 130 while the player 120 mounts the newly selected volume and positions the pickup to begin reproduction of the remainder of the selected program that follows the beginning segment. In addition, the “beginning segments” may be rapidly fetched from the memory subsystem to support manual or automatic scanning by the user who can then listen briefly to each program beginning to decide whether or not to listen to the remainder of the program. The “sweet spot” and longer “samples” of each program, as well as the volume sample that is representative of the volume as a whole, may be extracted for each CD along with the “beginning segments” when that volume is first mounted on the player 120, or later if metadata defining the location of sweet spots and samples is not yet available.

Additional data persistently stored in the memory subsystem characterizes each system user. That user data may include playlists which identify an ordered set of programs by volume and program number which the user may wish to play in the future, as well as a “usage log” which identifies the programs previously played (and not skipped) by each user. The usage logs may be used for a variety of purposes, including the automated creation of playlists of “favorites” (frequently played programs). Data stored for “user 1” and “user 2” are depicted at 137 and 138 respectively in FIG. 1.

As further illustrated at 139 in FIG. 1, the memory subsystem 130 includes a “content buffer” typically implemented in dynamic RAM, for storing blocks of program content which are prefetched from the player 120 for subsequent reproduction by one or more of the user controlled reproduction devices 142. The content buffers are filled from the disk player 120 which reads the disk at a higher rate (e.g. 8×) than the rate at which it is played back to the reproduction device(s). This allows the single disk player 120 to concurrently produce different outputs for different users using different reproduction devices, as explained in more detail below.

The system also stores “software” programs executable by the processor 110 or other devices, either in read-only memory (not shown) or the high speed memory subsystem 130, or both. New or improved functionality can be supplied by downloading new or replacement software from an available source via the I/O port 150. Unless otherwise apparent from the context, however, the terms “program,” “programs,” “programming” and “program segments” as used in this specification refer to audio or video program content, such as musical selections (“songs” or “tracks” on a conventional CD) or video programming (such as a “music video” selection), rather than to executable software programs.

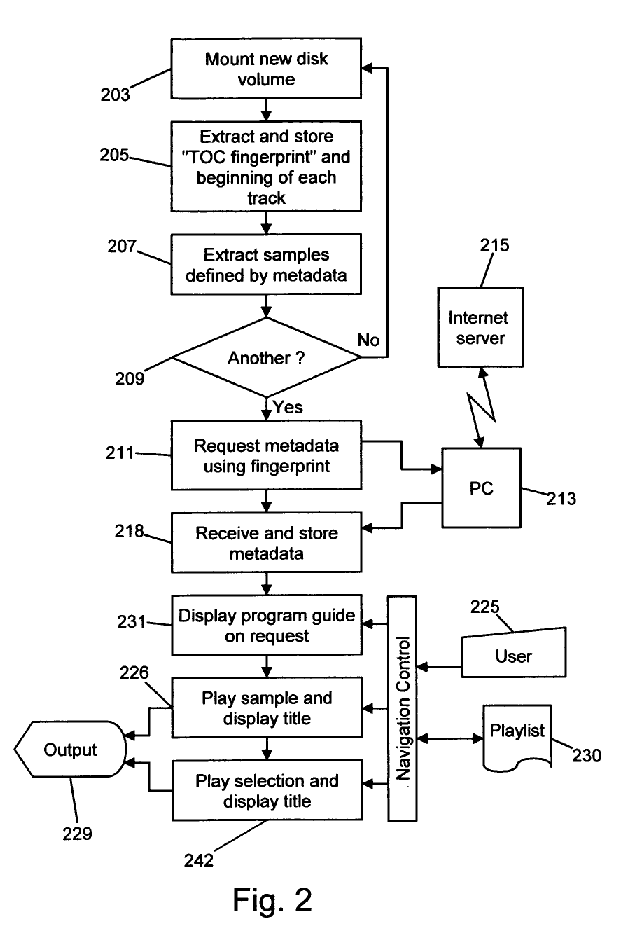

The procedure used by the improved CD player is shown in the flowchart of FIG. 2. A new volume is mounted in the CD player at 203. This can occur as a part of normal use, or when a collection of disks are placed in on the turntable or inserted into the carousel or magazine of a multi-disk player. Either before or during the playback of programming on each volume, the system automatically extracts a unique identification code from the CD as indicated at 205. This unique code or “fingerprint” can be extracted from the information stored in the CD's Table of Content (TOC), a lead-in area on the CD that contains data that is somewhat analogous to the table of contents of a book. Since each CD is unique in exact content, it is possible to use this the TOC information as a “fingerprint” to uniquely identify each CD volume. The TOC fingerprint data may be used by the player to identify each volume when it is loaded, and also enables the system to determine when a new CD has been mounted for the first time.

As also shown at 205, the system automatically retrieves the beginning of each individual program (e.g song track) on the CD. The duration of the beginning segment that is transferred to the high speed memory is preferably at least as long as the time required for the player to respond to a selection request requiring that a different volume be mounted from the turntable, carousel or magazine. Thus, if a particular multi-CD player requires maximum of eight seconds to change CDs, at least eight seconds of the beginning of each program on the newly mounted CD should be transferred to the high speed memory. In this way, when a program on that CD is requested when a different CD is currently mounted, the system can immediately begin playing the beginning of the requested program from memory as requested the CD holding the requested program is mounted, brought up to speed, and begins transferring the remainder of the requested program into buffer storage where it will be available to continue the playback at the conclusion of the pre-stored beginning segment. As a result, when a program is selected for playback from an unmounted CD, the playback can begin immediately.

After the fingerprint and beginning segment data has been extracted from all of the volumes placed in a multi-CD changer as determined at 209, additional metadata describing the contents of these CDs may be obtained by using the fingerprint data as a lookup key to fetch descriptive metadata about the contents of the CD(s) from an available source, such as a database server accessed by modem or Internet connection. One such system is described in U.S. Pat. No. 6,147,940 issued to Carl Yankowski on Nov. 14, 2000, the disclosure of which is incorporated herein by reference. Another such system is Gracenote's widely used CDDB® service (see www.gracenote.com) which provides an online database of music information with expanded album and track fields, credits, genres, ISRC code, and web-links that provide listeners with information about music that can be retrieved using the fingerprint data. Because the CD player may not have its own connection to the Internet, the retrieval of additional metadata may be accomplished by transferring the fingerprint codes to a personal computer (PC) or the like at 213 which then transmits the request for metadata to a remote server.

The metadata transferred from the server may include the identification of “sweet spots” as described in U.S. application Ser. No. 10/331,198 filed on Dec. 30, 2002 and published as Publication No. 2003-0163823, the disclosure of which is incorporated by reference. As described in that application, songs are known to have “sweet spots,” a brief portions of each song that resonates with, and is normally familiar to, listeners. Quite often this segment will be the refrain and include the title of the song as part of the lyrics. Sweet spots may be played to the listener during “scanning” when the playback jumps to the sweet spot in each song, if available, rather than the beginning segment. If the user likes the song, he or she can hit the skip button again to play the selection from the beginning, using the beginning segment that is also already stored in the high speed memory. To support this operation, the metadata may include either the “sweet spot” content, or a pointer to the sweet spot content on the actual CD. Thus, after the system retrieves the metadata from the PC at 218, the next time the volume containing the song is mounted, the sweet spot content pointed to by the metadata may be retrieved from the player and stored in the high speed memory. The scan control, seen at 228 in FIG. 2, may then substitute the sweet spot content for the previously extracted beginning segment during program scanning to provide the listener with a more immediate understanding of program content.

The received metadata, as well as the extracted beginning segments, sweet spots and extended samples, together provide an improved program guide and navigation mechanism to the user. The system responds to navigation commands from the user interface 225 by displaying text descriptions and playing samples of available programs. The visual display may take the form of a small LCD screen which shows scrollable list of titles that describe an ordered list of programs (e.g. song titles), or an ordered list of volumes (e.g. album titles). The ordered list of programs may represent the programs on a selected volume in track order, or may represent an ordered set of programs from a playlist 230. When the user moves the “cursor” to highlight a particular title, a more detailed text description of that selected item may be displayed on the screen and, at the same time, the beginning segment (or, if available, the sweet spot excerpt for that item) will be played for the listener. In this way, the listener not only sees the title, but hears a preview of each item of interest. The user may then use the user interface control 225 to either select a highlighted program for immediate playback, or it to a playlist 230 being built for future use. The navigation control 240 accepts commands from the user entered at the user interface 225, displays program listings as seen at 231, plays samples and displays titles of selected programs as seen at 226, and plays programs selected during navigation or from playlists while displaying song titles as seen at 242.

Multi-Listener Playback

The multi-listener features of the present invention may be used to advantage in compact disk players installed in vehicles. Many vans and SUVs have controls for the radio and CD player that are accessible by the backseat passengers. Passengers in the backseat may control the main (and only) radio and CD device with skip, volume, radio preset and controls. These backseat controls alter the sound that can be heard over the normal speaker system, or over headphones that plug into the backseat console, allowing these passengers to listen to the music privately. If headphones are used, the other passengers cannot listen to the selected music and in most systems they cannot listen to the other audio sources (the radio or cassette tape) either.

Increasingly then, passengers are listening to their own music sources. Between video systems in high-end cars, portable CD players, and back seat controls, many families consist of a car-full of passengers all listening to music of their own choice. The vehicle is becoming less of a place where people enjoy a common listening experience and more of where people want personalized music choice. Given this trend, the leading purpose of the “multi-listener player” features of the present invention is to allow greater playback choice by giving two or more people the ability to listen to different programs (e.g. tracks) on the same player. The principles of this aspect of the invention may also be applied to provide multi-listener capabilities to CD or to a MP3 collection stored on a hard drive, or any other sort of device delivering digitally encoded music.

Currently, many CDs already have “anti-skip buffer,” often 45 seconds long, to provide proper playback even when the drive skips tracks. The anti-skip feature is commonly incorporated into portable players and players installed in vehicles that are subject to shock and vibration that may cause the pickup to skip tracks. By buffering content read from the disk at a higher rate in advance of playback, when a track jump occurs, the output reproduction device can continue to play from the buffered content while the pickup head is repositioned to capture the skipped content. This present invention also uses buffered content, perhaps in expanded form, to provide another function: supplying a second listener with different program content.

Individual program choice is needed even for a single-CD player. Because the system contemplated by the invention can potentially make available a large number of program selections on one or multiple volumes, it would be unlikely that any two people would be interested in listening to the exact same program or playlist at the same time. Therefore, a personalized navigation and listening feature for that category of device would definitely be valued. For a multi-CD changer, with six or more CDs able to be accessed on demand, the chances of two people wanting to hear the same tracks, at the same time, assuming they had the option for personalized listening via headphones, would be small. Even with a single CD, different people in the car would most likely have different opinions regarding which song to play next, or replay, etc. And with MP3 recordings on compact disk or in a hard drive, many times the number of songs as one standard CD are commonly available, still further reducing the likelihood of two people will want to hear the same program content at the same time.

What might the alternatives be to creating two personalized playback streams off of one or more CDs? One solution is to have two CD players in the car. But the backseat listener will still have to wear headphones. This solution also increases cost, uses scarce surface area, locates a breakable device in the back seat, and increases the difficulty of locating CDs which become spread over the car. In addition, with two CD players playing two CDs, it is difficult to share a common listening experience when that is desired. By using the multi-listener capabilities described here, the two listeners may be listening to different programs on the same CD listening to the same CD, which can't be achieved using separate players. Using these capabilities, a usage session might start with both the front seat and back seat listeners hearing the same thing. As soon as the backseat listener's taste diverged from the front seat listener's, the headphones could just be slid on and a new track found. No more fights until the CD was over. At the same time, it is possible for two users to listen to the same CD at the same time.

For each device, one or more playback channels would be needed, one for the “public” speakers and one further output channel for each set of headphones. The player 120 seen at 120 is shared and retrieves and decodes the audio from selected CD volumes in faster-than-real-time. Most conventional CD mechanisms can play at 8× real speed, although most consumer players don't make use of this feature. As content selected by each listener is read from the mounted CD, it is stored in the content buffer 139 typically implemented by dynamic RAM which forms part of the memory 130. After the content is stored for one output channel, the player 120 then reads a block of upcoming content for another listener from program and places that in the buffer. Programming is then supplied to the reproduction device (e.g. headphones used by one person) from the allocated buffer while the player goes to a different track to “fetch” upcoming programming for the second listener who may be using the systems “public speaker.”

If just one channel were playing, a buffer of decoded audio content is stored. If another selection were requested by a second user for a different output channel, the initial song would continue to play off the buffer, the previously stored beginning portion of the other selection is routed to second user as the playback device selects and reads data from the new selection into the buffer. This second song too, would get it's own buffer, enabling the decoder to go back and decode more of the original song. The processor/decoder would continue this process of shuttling back and forth, fetching a buffer's-worth of audio each time. The rate of shuttling back and forth depends on the following considerations:

a. how much of a delay the second listener is forced to endure before his or her music starts;

b. the size of the buffer for each listener;

c. the rate the CD can be decoded;

d, how much music, if any might have been pre-stored in the first listener's buffer, even if no second listener presented a request; and

e. the amount of “overhead time” taken to get from program to program (e.g. from track to track on a single CD, or from volume to volume if programs are selected from different volumes on a multi-volume player).

More than two listeners may be handled in this way, with the number of listeners being limited only by cost (a function of the number of audio channels, needed buffer space, and the respective reproduction devices and controls for each listener) and the ability of the disk player to shuttle back and forth.

In all variants a simple user interface would allow each listener the independent ability to skip ahead, pause, etc. These controls could be adjacent to existing listener controls, perhaps allowing the same controls to apply to different users via a toggle switch. Ideally, the controls for each user would be within reach, perhaps located on the headset. The secondary listeners might have a simplified set of controls, also.

Soon Bluetooth technology provides cost-effective wireless transmission of both control signals and audio data over a short range, a plurality of independent user reproduction devices as depicted generally at 142 in FIG. 1 can be used, each of which consists of a Bluetooth transceiver, individual user interface controls, and headphones. Each user's unit communicates to a Bluetooth transceiver at 141.

CD-Changer with Seamless Play

A second important feature of the system provides improved performance when two successive programs routed to an output channel reside on different CD disk volumes in a multi-volume changer. CD-changers with five CDs take on average 7 seconds to change a CD. Carousels holding several hundred CDs take even longer (e.g 20 seconds). When hitting the skip button to change songs on a single CD volume, however, it only takes about 0.5 seconds to change from one track to another. A system designed to make multi-volume player perform as well as a single CD player or a single collection of digital MP3 songs would ideally reduce playback delay that now occurs between programs when volumes need to be switched on the transport.

This system uses the high speed memory 130 in combination with a slower, multi-volume changer 120 to reduce the apparent time taken to change CDs. This important improvement is provided without requiring any change in the users' behavior, and does so using components that are already present in the system to provide other functions described in this specification.

In addition, the memory-based reduction in volume switching times achieved may reduce manufacturing costs by relaxing the requirements placed on the changer since a slower, and less expensive disk transport mechanism may be used because the mechanical requirements for the moving parts needed to switch tracks are less stringent.

In addition, other features of the system permit the programs available on multiple CDs to be scanned or selected using a program guide by reading metadata and listening to program excerpts stored in the high speed memory. As a result, the user is more likely to select programs on different CD volumes, and to construct playlists which invoke programs distributed over multiple volumes. This capability increases the need for more rapid switching between desired programs on different CDs. Reducing the switching times between different CDs would yield the following benefits:

1. start the next program without a significant delay when switching volumes;

2. switch more rapidly between songs designated by cross-CD playlists; and

3. permit the player to execute a cross-CD automatic “shuffle” of programs, a function that is impractical today with changers which require a significant amount of time to switch from one CD volume to another.

The improved switching times is achieved by storing the beginning of each program on each CD in the high speed memory 130. Then, when a program on a track on an unmounted CD is requested (either by a manual selection from the program guide, by reaching the next program on a cross-CD playlist, or by executing a cross-CD program shuffle, the new selection can start playing almost immediately by using beginning content stored in memory. The beginning content has a sufficient duration to permit the transport to mount the newly selected volume, position the pickup, and read the next block of content data following the beginning segment into the buffer memory for continued playback.

When switching from CD to CD, the user may be “sampling CDs”—looking for a favorite CD to play at that moment. As long as the user is only listening to excerpts of the candidate program (either beginning segments, sweet spots, or longer samples), the changer need not be requested to mount a new volume. Thus, for example, if the user is “scanning” a playlist, listening only to the beginning segments from the high speed memory, and listens to the beginning segment for less than a certain minimum time period used for the “automatic skip,” the actual CD volume might not need to be mounted. This would allow the listener to sample multiple CDs quickly with no movement of CDs needed—and of course, no lag-time to hear a sample from each CD. A further feature of such a system would allow the system to recognize the most popular song (based on past listening patterns) on each CD and buffer and play that first as the representative sample. Alternatively, the metadata may identify a sample which is representative of the entire CD, for example, a sample of the “title song” for an album CD, or from the most popular song on the CD.

In the above example, it would be assumed that the listener was out of “sampling mode” after listening for a set time period to the same track. The CD at that point would be fetched while the song was still playing out of the buffer. Alternatively, the system could try to fetch the CD as soon as possible, playing the song out of memory in the meantime. In the time period before the CD was fetched, certain features related to a loaded CD would not work, such as the ability to rapidly scan forward through the song, at least past the pre-stored portion.

The system would have to be designed to seamlessly merge the buffered and CD-based music together, just as the stored buffer is reassembled with later content read from the CD when an anti-skip buffer encounters a skip and must synchronize the incorrectly omitted material captured later with the originally read content in the buffer. The system would need to know the exact endpoint of the previously stored buffer and have a means to jump to the content immediately succeeding the content representing the end of the buffer.

To set the system up, the music would be encoded in memory immediately after a new CD was placed in the changer. A sensing mechanism to detect the replacement of a CD would be needed. When a change was detected, the player would go and encode the song beginnings for each song and put it in the proper place in memory.

If the system was busy playing music at the time that encoding needed to be done, time could be freed up in a manner to that has been proposed for the Multi-Player CD system. That is, the player would decode music off the current playing track at a rate faster than real time. This music would be loaded into a buffer for playback in real time. Meanwhile, the processor would have time to encode the new CD. After a program has been read from the player to supplement the beginning portion already stored, the entire content may advantageously be left in the buffer until the program has been completely played out. This allows the user to request a replay of the recorded material which may occur after the system has begun to read the next scheduled program into the buffer.

Using a localized version of the CDDB algorithm, the CD changer could identify each CD. If a certain CD were just moved to a different spot on the changer, the songs would not need to be re-ripped.

Cost

The preferred embodiment would store at least 10 seconds from each track on the CD, or roughly 200 seconds per CD. For a 6-CD changer, the memory requirement would be on the order of 1,800 seconds or 30 minutes of audio. This would be equivalent to 30 megabytes of memory using standard compression techniques. The wholesale cost of this amount of memory capacity would currently be approximately $3 dollars, and that cost can be expected to continue to decrease dramatically in coming years. The hardware or software needed to do efficiently demodulate and decode the digital content data on the CD presumably is already on the player but might need to be supplemented in order to perform simultaneous decoding of multiple streams, or to decode single streams more rapidly on a time-shared basis.

A lower cost system requiring less memory would only buffer the beginnings of first song of each CD. This system would offer the benefit only of minimizing the wait time while switching CDs but not offer cross-CD playlists or shuffle. If the listener tried to move to the next track on the new CD, however, the song would not be buffered and a wait would result while the CD was fetched.

The cost to implement the system on a 300 CD changer might currently be prohibitive for low cost units, but that is expected to change over time. One way to address the cost issue in the short term would be for the system to recognize the differences in playing frequencies between songs and only set up buffers for songs played frequently or that were in specified playlists.

The concepts discussed become more practical in a world of convergence of the Internet with conventional broadcast, cable and disk media channels. For instance, the Tivo digital video recorder (DVR) will now be able to download and play music off the Internet. With multi-purpose devices like this emerging, many of the hardware requirements can be offloaded to other parts of the systems including processing power and encoding resources. If a hard drive were available, much of the storage needed for buffering could reside there instead of in a semiconductor memory, thus cutting costs (as the access time off of a hard drive is still many times quicker than switching CDs) and making possible the storage of sample excerpts from many disks in a high capacity changer.

Another architecture to consider when the changer is connected by a high speed link to anther device is one in which the memory needed by the player resides in a remote device, such as a PC. Thus, if the player were connected to a PC via a Bluetooth device or WiFi link, or to the Internet, either directly, or via the PC, then the buffered content can be accessed via a communication link. This would reduce memory requirements on the player. Copyright issues might be resolved to the extent that the samples stored on the web server or PC were de minimus copies or allowed because the user had purchased the actual discs.

Players with an Archival History.

This third improvement to CD, DVD and similar playback devices allows the player to keep a history of all previously played content as a means to automatically and easily create an index of owned content. The player preferably includes additional memory and some sort of network connection to implement the system.

When music is stored on the hard drive of a PC, the user approximate an electronic program guide (“EPG”) with click-and-play capabilities. This PC-based EPG is the file structure that is automatically stored for the user's MP3 collection by existing software that makes copies from a CD. Metrics about the number and length of tracks (TOC data) are developed during the ripping process yielding a unique “fingerprint” about each CD. Jukebox software such as Music Match then goes to the web to download metadata from the CDDB database. This metadata is used to organize the songs by CD, artist, etc. This same structure of organization is available for MP3 recordings on CDs that are recorded by the user.

But when dealing with CDs or other physical media, remembering what music you own and what it all sounds like, is a problem which the user must solve when selecting the music (a “pull” system compared to a “push” broadcast where the listener passively listens to what the radio plays.)

There are several ways to navigate through your physical collection of CDs.

1. Some CD changers are equipped with keyboards that are used to type in the name of the albums that have been put onto the carousel. These names show up on an LCD display when that particular album is being loaded.

2. More advanced CD changers now come with Internet connections that match a CD mounted in the changer with the CDDB, automatically downloading metadata about the CDs into the changer and giving the user a list of what of the programs stored on that particular changer.

The two methods above will tell the user what programs are currently loaded into the CD changer, but do not provide information on all the rest of the CD's in the owner's collection? There are two methods can currently be used to deal with this problem:

1. The user can flip through the jewel cases. This can be done via spinning carousels, or by manually going through a stack.

2. The user you can use a keyboard to create a text list of all of the owned CDs.

But all these methods still leave the problem of associating the name of the song and artist with the actual sound (akin to the mental energy required to envision the taste of food listed on a menu). None of these browsing or search methods serve to help to remind the listener what the respective music sounds like. This issue, however, is handled by the using navigation systems (e.g. automatic scanning) and program guides that present brief recorded samples extracted from each available program.

A similar navigation and “inventory recognition” problem exists for video content in a DVD collection, you might have” problems. After building a library of discs so the viewer has a selection of available programs, the problem then becomes remembering which movies you've seen and which ones you've bought but haven't seen when you are shopping for new DVDs.

The purpose of this aspect of the system is to use the playing device itself to compile, over time, a list of discs owned by the user and collect data about the use of those disks.

The arrangement envisioned here comprises a network-connected disk player, CD or DVD, with a communications capability of connecting to CDDB or an equivalent database residing on a network. The device could be connected either directly to the Internet or a local PC. The connection could be a wired one (even a docking station for a portable player), or a wireless one such as a Bluetooth connection.

Every time a disk was inserted, metadata about the disk would be generated. This metadata would be either sent to the CDDB-like database at that time or batched for later transmission. The metadata would be used to fingerprint and identify the disk. The result is a history of all the disks that “passed through” the device and how they were used.

This ID information could be passed back to the device, stored, and displayed the next time the device played a matching disk even if there was no network connection at that time. Thus, a portable CD player could over time learn the fingerprints of all the CDs in the owner's library and when each was played, could display the song, artist and album information even if off-line.

This aspect of the system envisions the compilation of an inventory list or directory of the user's entire collection of owned CDs and DVDs, with no effort being required on the part of the user. The resulting list may then be printed out, managed manually, displayed on the disk player, or accessed at an in-store kiosk, or a web-enabled PDA.

This Archived CD List provides a new way to navigate the user's entire collection of CDs, which could be scattered in any number of locations. It provides a reminder of the potential CDs that could be put into the changer and represents a virtual compilation of “playable” CDs. that could be played if the CDs were changed.

In some ways it is akin to the feature some telephone now have whereby they list the last 100 calls received. Thus, while you might be on line talking with one party, with a little effort, you can scan the archive of received calls and get on the phone with another party. In much the same way, CDs in the Archive can be identified and retrieved with an effort only somewhat greater than accessing the ones in the changer at the moment.

A further feature would have the system suggest which CD to remove from the carousel when a new one was to be added. This could be done by tracking usage data for each CD and suggesting the least-used CD be removed.

A large CD changer is a special case as the unit might hold a large percentage of a user's collection and some of these devices are already connected to the CDDB over the Internet. For this implementation the CDDB-equipped CD changer would have two lists—a list of Active CDs and Archived CDs. If a CD is moved from the changer, the corresponding data is relocated from the “Active” portion of the local CD-changer database and put in the “Archive” section. This Archive database displays, then, the names of all the CDs that have ever “passed through” the changer previously. In a sense, it is a list of all the CDs that the user owns—assuming that they all have at one time or another been played on the changer. Because the changer is connected to the network, the Active and Archive lists could reside in the changer, a PC, or on the network.

A further use of the system would be to document a history or diary of playback activity. Thus, the system could keep a record of where the user left off when playback of a movie ceased during a previous session. Bookmarks for other uses could also be created.

Services Based on Usage

As indicated at 137 and 138 of FIG. 1, data regarding “consumption” of the media would be compiled over time and stored on the device, a local PC, or the network. This data could indicate which disk was listened to or watched, at what time, etc. By knowing what movies have “passed through” a user's DVD player, which ones had been finished, etc., a service provider could make recommendations for future movie purchases. With an interactive CD or DVD player, listeners and viewers could also “vote” by supplying a thumbs up or down rating, or a numerical rating, for each album or song listened to, or to each movie viewed, to obtain music and movie recommendations from a service matching the users preferences. By contributing his or her recommendations to a service which aggregates the recommendations of many users, data can be developed which provides recommendations to a user which indicate other programming which other users having similar preferences highly recommended.

Other uses for the data would be personalization services (such as systems that monitor a user's listening habits across different devices to be able offer personalized ads and discounts), community sharing, or use by another “smart” CD player in constructing playlists or allowing “intelligent” shuffling based on song desirability, etc. Usage data could also be used by the emerging subscription services to track compliance or aggregate customer behavior.

Information across multiple users could be compiled in a manner similar to how Tivo compiles information regarding its users' time-shifted media viewing habits. Collection, and possibly resale of this information could be the quid pro quo for using the service. This type of information aggregation model would allow an entirely new class of information to be collected about the use of the disk media in a manner similar to how data is compiled for broadcast media—data that could be sold to content producers and others.

Playlist Management

With the hardware described above built into a CD changer, and metadata about the CDs that reside on the carousel available to the system, the user would now have the ability to easily construct playlists across CDs. Using the “Seamless Playback” method described above, the playlist playback could be seamless and it would appear that the songs were all residing on the same CD.

Playlists could be developed in a number of ways:

1. They could be developed at a PC via a web-based (do-it-from-anywhere) application or at a PC that communicates with the changer in one of the ways described above.

2. Playlists could be developed “manually” by the listener by issuing a command as the list of available songs scrolled by on the changer's display. Alternatively, the keyboard that hooks up to the changer could be used to navigate the list and select songs, and furthermore, label the playlist.

3. The changer could also keep track of which songs were played the most, or played with each other. With certain usage algorithms employed, the system could attempt to automatically generate clusters of songs the listener appears to like to hear together when given the opportunity to “surf and play”. These algorithms could be run on either the changer's microprocessor or the connected PC. The simplest such algorithm would be “play the last 20 songs I played when I controlled the selection of CDs and songs played”. This usage data could be used not only to produce playlists but also to rank order CDs or songs by playing frequency within a certain time period. You could select to play items directly off this list.

As mentioned in connection with Seamless Playback above, adding memory would allow for the implementation of the shuffle function across CDs, as there would be no delay while changing CDs. This idea could be further extended when listening data is integrated into the function.

When shuffling amongst so many songs, it would be advantageous to narrow down the universe within which shuffling is occurring. By using popularity data, that is, knowledge of how many times each song on the carousel had been played over a certain time period (perhaps relative to how long it had been placed on the carousel), the universe of songs to shuffle could be reduced to songs you liked to hear most often. The degree of such concentration of listening could be modulated via the keyboard, PC, or web interface. In addition to using your own listening history, collaborative data could be interjected (assuming a network connection) to supplement or replace the personal data.

A Scan Button for Digital Content

The fourth novel method for improving the operation of CD and DVD players relates to the use of a “scan” button that provides a new method for sampling and experiencing digital music collections. The scan button provides an audio aid for navigating a collection of owned CDs and a way to see previews of owned DVDs. The system would ideally employ both device connectivity and memory.

Today, more owned music then ever is being collected in devices or services that make it all available at once without having to fetch individual CDs. Not only there CD-changers, there are growing MP3 collections on computers, MP3-CDs, which hold ten times the number of songs that standard CDs hold, and subscription services, which give listeners access to a wide range of songs on-demand, albeit, sometimes just for a specified period of time. Soon to be available, will be radio recorders like Gotuit Radio that will store large amounts of recorded radio programming. These aggregations of music will present greater navigation challenges due to their size, but at the same time offer greater benefits from improved navigation if such methods allow you to get to the music you want, when you want it.

In today's music world there is a scan button only for radio broadcasts—the predominant “pushed” media for music. When the user hits the scan button, a sample from successive stations is presented until one is chosen. It is a somewhat crude, but popular, feature.

For owned music, where listeners “pull” what they want to hear, there is no such button. It is assumed that listeners know what they own and can go right to it. The closest feature to a scan button is the “shuffle” button, which takes an owned collection from which a listener normally “pulls” selections, and turns it into a “push” means. In the “Smart CD” methods described above, it was noted that portions of songs may be stored in memory to facilitate seamless disk changing. In addition, the creation of an archival list of previously played disks was discussed. Here the ideas are brought together in a system designed to offer listeners a way to sample their way to the music they want to hear.

Users can use an “intelligent Scan” button to sample and select music from their collections. These collections might be MP3 compilations, MP3 CDs, CD-changers, etc. This Scan button would take the listener from song to song until a desirable selection appeared.

The Scan button might have the ability to jump to the following locations within a song:

1. It could take the listener to the beginning of the next song and play a segment

2. The listener could be taken to a random location within the next song.

3. If the unit were Internet-enabled, metadata concerning the song could be obtained, and the sample could begin at the “sweet spot” of the song—that portion of the song that most resonates with listeners.

4. A set of algorithms could deduce the location of segments within the next song such as the refrain, which might be most recognizable to listeners

5. The location method could be personalized by listener

6. A rotating mix of the above

In the case of methods 3 and 4, an algorithm that analyzed patterns in the song, looking for various attributes or a repeating pattern, most likely the refrain, could deduce the location of the sweet spot. The sweet spot could also be determined via metadata drawn from a database. Such databases are at the heart of several websites that offer intelligent samples for songs.

The scan button could also just sample as few as one song per CD—an approach that would be focused on helping the listener pick which CD from a set to listen to.

The Scan button could also employ different techniques in choosing which song to sample next. For instance, it might:

1. Scan through those songs listened to most frequently by the listener

2. Scan those listened to least frequently

3. Combine the scanning function with the shuffle function and scan random songs

4. Scan the songs in a playlist

5. Scan sample songs from multiple playlists

Samples from Archived Content

Another implementation of this system would be for the device to extract samples from the owner's archives—all the disks that had passed through the disk player in the past. This would allow the presentation of samples of the user's entire collection of content and not just those disks available to the player that time. The purpose of this feature would be to remind the listener what other disks were available for play. In this embodiment, the DVD player is as much a target platform for the invention as the CD player. For instance, one could use such a system to see previews of all the DVDs in a collection.

The same options noted above, concerning sample locations and songs or DVDs to sample, would apply to the archives as well.

These samples for the Scan button, which are not coming from the physical disks (by definition this implementation deals with media not currently in a player), could reside on the Web, a local PC connected to the device, or the device itself. The samples could be played at the device itself if stored there or communicated via a connection to the storage location. Alternatively, the Scan button and the playback could reside in another location such as a local PC, or both.

The samples themselves, while possibly originating by ripping the owner's disks, might also be obtained from free sources of samples on the web, or be made available by content holders to owners of the disks, a la a Beam It-like service. If these were streaming sources, then the system would store a list of the owned material, and go to the web to collect samples on the fly. If downloads were permitted, the samples might be downloaded and stored ahead of time.

The playback from the CD or DVD sample could even be seamless if enough content was stored in the buffer to allow the user to get the missing disk and put it in the changer while the buffer was playing. To this extent, the device could be playing from memory while the disk was being fetched.

In one version, the listener would hit the Scan button and the unit would start to play samples from the beginning of the content segment. When the user indicated a desire to play the entire song or CD, an audio indication or voice would indicate that the user needed to put the CD or DVD into the player.

Conclusion

It is to be understood that the methods and apparatus which have been described above are merely illustrative applications of the principles of the invention. Numerous modifications may be made by those skilled in the art without departing from the true spirit and scope of the invention.

What is claimed is:

1. Apparatus for concurrently reproducing different program performances recorded on the same audio or video media volume for two different users comprising, in combination,
a high speed random access digital memory,
first and second output devices each for reproducing one of said different program performances in a form perceptible to one of two different users at a reproduction rate approximately equal to the rate at which said program performances were originally captured for recording on said media volume,
a media player including a pickup responsive to a selection signal for generating a digital output signal representative of selected program performances recorded on said media volume and for transmitting said digital output signal to said digital memory at a faster rate at least twice said reproduction rate,
first and second user interface devices, each of which accepts program selection requests from one of said two different users, and
a controller coupled to said digital memory, to said first and second output devices, to said media player, and to said first and second user interface devices, said controller comprising:
means for transmitting a first program selection signal from said first interface device to said media player to transfer at least the beginning portion of a first of said different programs from said media player to said digital memory at said faster rate,
means for transferring said first of said different programs to said first output device to reproduce said first of said programs for said first user at said reproduction rate, and
means for transferring a second program selection signal from said second interface device to said media player to transfer at least the beginning portion of a second of said different programs from said media player to said digital memory at said faster rate, and
means for transferring said second of said different programs to said second output device to reproduce said second of said different programs for said second user at said reproduction rate at the same time said first output device is reproducing said first of said different programs for said first user.
